(19) United States
(12) Patent Application Publication
(10) Pub. No.: US 2023/0023310 A1
(43) Pub. Date: Jan. 26, 2023

(54) VARIABLE DISPLACEMENT PUMP SYSTEMS WITH DIRECT ACTUATION

(71) Applicant: Hamilton Sundstrand Corporation, Charlotte, NC (US)

(72) Inventor: Edward W. Goy, Crystal Lake, IL (US)

(73) Assignee: Hamilton Sundstrand Corporation, Charlotte, NC (US)

(21) Appl. No.: 17/384,466

(22) Filed: Jul. 23, 2021

(51) Int. Cl. F02C 9/26; F02C 7/232; F02C 9/30; F02C 9/22

(52) U.S. Cl. CPC F02C 9/263; F02C 7/232; F02C 9/30; F02C 9/22; F05D 2270/3015; F05D 2240/12; F05D 2240/24; F05D 2260/406

(57) ABSTRACT

A variable displacement pump can include a rotor having a plurality of vanes, a cam ring surrounding the rotor and vanes, the vanes configured to extend from the rotor and contact an inner cam surface of the cam ring, and a retainer configured to contact the cam ring and to move the cam ring relative to the rotor to modify a pumping action. The pump can also include a direct actuation mechanism configured to control a position of the retainer to control a position of the cam ring and the pumping action.

### FIELD

This disclosure relates to variable displacement pumps.

### BACKGROUND

Typical variable displacement pumps (e.g., for aircraft fuel systems) have complex hydraulic controls. However, these controls are indirect and present a lag between input and output, as well as reliability issues.

Such conventional systems have generally been considered satisfactory for their intended purpose. However, there is still a need in the art for improved variable displacement pump systems. The present disclosure provides a solution for this need.

### SUMMARY

In accordance with at least one aspect of this disclosure, a variable displacement pump can include a rotor having a plurality of vanes, a cam ring surrounding the rotor and vanes, the vanes configured to extend from the rotor and contact an inner cam surface of the cam ring, and a retainer configured to contact the cam ring and to move the cam ring relative to the rotor to modify a pumping action. The pump can also include a direct actuation mechanism configured to control a position of the retainer to control a position of the cam ring and the pumping action.

In certain embodiments, the direct actuation mechanism can be an electrohydraulic servo valve (EHSV) in direct hydraulic communication with the retainer via a hydraulic piston. In certain embodiments, the direct actuation mechanism can be a non-hydraulic electromechanical arm assembly. The non-hydraulic electromechanical arm assembly can include a servo motor or screw actuator.

The pump can include a controller configured to directly control the direct actuation mechanism to achieve a desired pumping action. In certain embodiments, the pump can include a biasing member configured to provide an opposing force to a direction of force applied by the direct actuation mechanism to bias the retainer in a bias direction.

In certain embodiments, the pump can include a housing. The retainer can be disposed on a pivot pin at a pivot location between, on, or in the retainer and the housing to allow the retainer to pivot relative to the housing.

In certain embodiments, the retainer includes a tab opposite or otherwise located apart from the pivot location, the tab configured to interact with an arm of the direct actuation mechanism to allow the direct actuation mechanism to apply a force to the tab to rotate the retainer about the pivot pin. A biasing member arm can be disposed on an opposite side of the tab relative to the arm of the direct actuation mechanism to provide an opposing force to a direction of force applied by the direct actuation mechanism to bias the retainer in a bias direction. In certain embodiments, the bias direction can be a maximum pumping action direction.

In certain embodiments, the direct actuation mechanism includes a first arm and a second arm disposed on opposite sides of the tab. The first arm and second arm can be configured to have complimentary actuation such that extension of the first arm causes retraction of the second arm to control the position of the retainer without a biasing member on the retainer.

In accordance with at least one aspect of this disclosure, a fuel pump system for an aircraft can include a fuel circuit, and a variable displacement pump connected to the fuel circuit. The pump can be any suitable pump disclosed herein, e.g., as described above.

In accordance with at least one aspect of this disclosure, a method for controlling pumping action of a variable displacement pump can include directly controlling a position of a retainer to directly control pumping action of the pump using an electrohydraulic servo valve (EHSV) or a electromechanical arm assembly. The method can include any other suitable method(s) and/or portion(s) thereof.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1A is a schematic cross-sectional diagram showing an embodiment of a pump in accordance with this disclosure, showing a retainer positioned in a no-displacement position;

FIG. 1B is a schematic cross-sectional diagram of the embodiment of FIG. 1, showing a retainer in a maximum displacement position;

FIG. 2A is a schematic cross-sectional diagram of another embodiment of a pump in accordance with this disclosure;

FIG. 2B is a schematic cross-sectional diagram of another embodiment of a pump in accordance with this disclosure;

FIG. 3 is a schematic diagram of an embodiment of a pump in accordance with this disclosure, shown in operation in two different states; and

FIG. 4 is a schematic diagram of an embodiment of a system in an aircraft in accordance with this disclosure.

### DETAILED DESCRIPTION

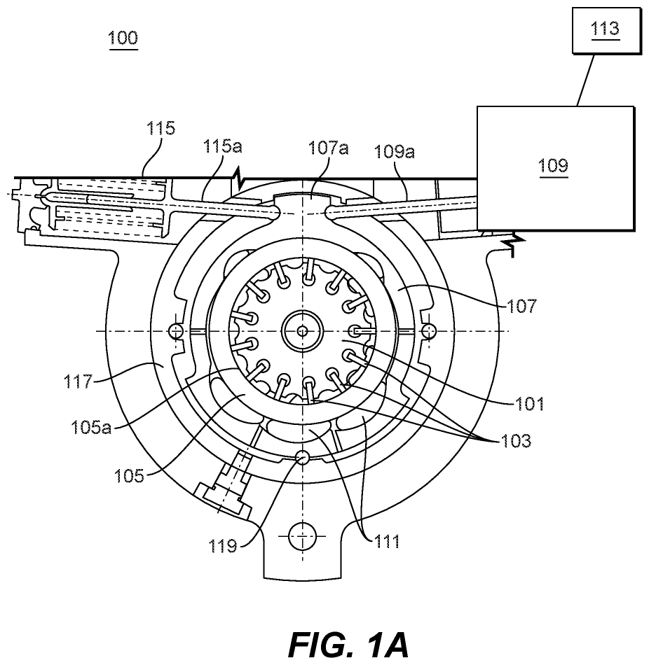

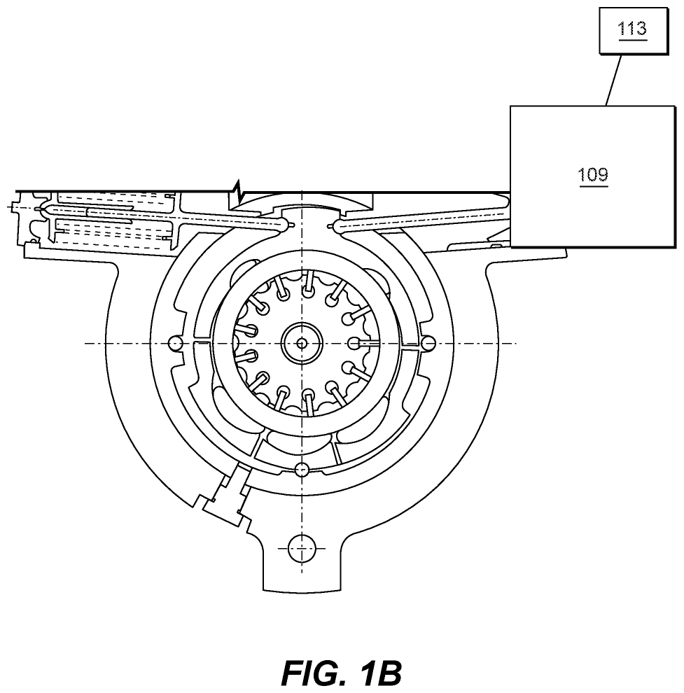

Reference will now be made to the drawings wherein like reference numerals identify similar structural features or aspects of the subject disclosure. For purposes of explanation and illustration, and not limitation, an illustrative view of an embodiment of a variable displacement pump in accordance with the disclosure is shown in FIGS. 1A and 1s designated generally by reference character 100. Other embodiments and/or aspects of this disclosure are shown in FIGS. 1B-4.

Referring to FIGS. 1A and 1B, a variable displacement pump 100 can include a rotor 101 having a plurality of vanes 103 disposed therein. The pump 100 also includes a cam ring 105 surrounding the rotor 101 and vanes 103. The vanes 103 can be configured to extend from the rotor 101 and contact an inner cam surface 105a of the cam ring 105. The vanes 103 can be configured to slide radially relative to the rotor 101 to contact the inner cam surface 105a. The vanes 103 can be outwardly biased.

In certain embodiments, the cam ring 105 can be a rotating ring configured to reduce relative motion between the vanes 103 and the cam ring 105. This can reduce frictional losses without affecting pumping action as appreciated by those having ordinary skill in the art in view of this disclosure. A stationary cam ring or any other suitable cam ring is also contemplated herein.

The pump 100 can include a retainer 107 configured to contact the cam ring 105 and to move the cam ring 105 relative to the rotor 101 to modify a pumping action. The pump 100 can also include a direct actuation mechanism 109 configured to control a position of the retainer 107 to control a position of the cam ring 105 and the pumping action (e.g., the displacement of the pump 100). For example, the retainer 107 can surround the cam ring 105 and include any suitable number of pieces. One or more tilting pad bearings 111 can be disposed between the cam ring 105 and the retainer 107.

In certain embodiments, as shown in FIG. 1, the direct actuation mechanism 109 can be an electrohydraulic servo valve (EHSV) in direct hydraulic communication with the retainer 105 via a hydraulic piston (e.g., arm 109a). The EHSV can be controlled via an electrical input to set the pressure observed by the hydraulic piston which is in direct mechanical connection with the retainer. The EHSV can receive current from an engine controller which can set the demanded amount of flow, for example. Based on the current, the EHSV can send along some mixture of pressure between inlet and discharge pressure to the actuator piston. The actuator piston will move if the pressure*area results in enough force to overcome the spring load (e.g., and miscellaneous friction forces) and will reduce the flow (therefore reducing discharge pressure). A traditional vane pump needed to include pressure compensation valves in the system to try to adjust the actuator piston location hydraulically. However, instead of utilizing pressure compensation valves, for example, EHSVs can now control the actuator piston directly rather than with pressure compensation valves also being required in the system. In this regard, the EHSV can be directly hydraulically communicated to the actuator piston. Any suitable hydraulic control assembly to directly hydraulically control the arm 109a is contemplated herein.

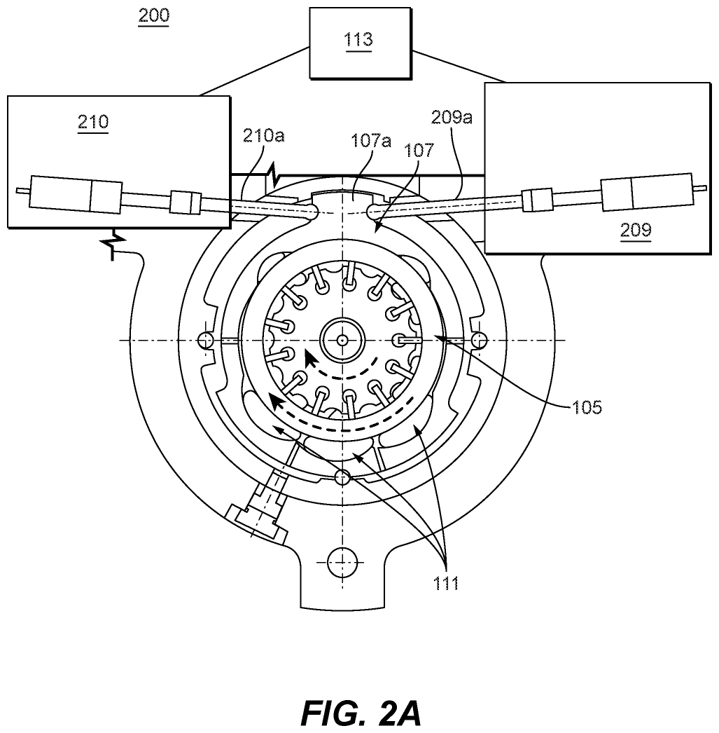

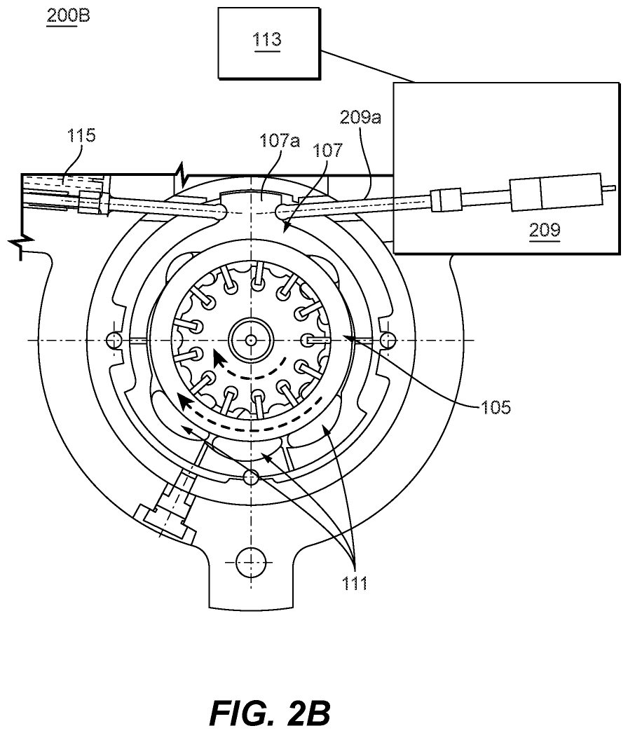

In certain embodiments, referring for example to the pump 200 of FIG. 2A, the direct actuation mechanism 209, 210 can be a non-hydraulic electromechanical arm assembly. For example, the non-hydraulic electromechanical arm assembly 209, 210 can include a servo motor or screw actuator, e.g., as shown.

Referring to FIGS. 1A-2, the pump 100, 200 can include a controller 113 configured to directly control the direct actuation mechanism 109, 209, 210 to achieve a desired pumping action (e.g., to modify displacement between no displacement, e.g., as shown in FIG. 1A, and a maximum displacement, e.g., as shown in FIG. 1B). The controller 113 can include any suitable hardware and/or software module(s) as appreciated by those having ordinary skill in the art. Certain embodiments can include one or more feedback sensors, e.g., a position sensor on the actuator arm 109a or on the pivot pin (described below) to determine what the displacement and/or pump pressure should be. Embodiments of a controller 113 can control the EHSV based on a position sensor, for example. The controller 113 can be configured to cross-check the sensor readings with actual flow pressure, for example.

Certain embodiments can utilize differential pressure transducers that read the difference between the inlet and discharge pressures to provide feedback to the controller 113. The controller 113 can then change the current to the EHSV to directly change the displacement of the pump 100 to reach the demanded pressure via displacement changes.

In certain embodiments, the pump 100 can include a biasing member 115 configured to provide an opposing force to a direction of force applied by the direct actuation mechanism 109 to bias the retainer 107 in a bias direction (e.g., toward maximum displacement such that in the event of failure, maximum pumping action is provided). This can allow actuation from a single side of the retainer 107 and provide a desired failure mode.

In certain embodiments, the pump 100 can include a housing 117 (e.g., that surrounds the retainer 107). The retainer 107 can be disposed on a pivot pin 119 at a pivot location (e.g., a bottom) between the retainer 107 and the housing 117 to allow the retainer to pivot relative to the housing 117.

In certain embodiments, the retainer 107 includes a tab 107a opposite or otherwise located apart from the pivot location. The tab 107a can be configured to interact with an arm 109a of the direct actuation mechanism 109 to allow the direct actuation mechanism 109 to apply a force to the tab 107a to rotate the retainer 107 about the pivot pin 119. A biasing member arm 115a can be disposed on an opposite side of the tab 107a relative to the arm 109a of the direct actuation mechanism 109 to provide an opposing force to a direction of force applied by the direct actuation mechanism 109 to bias the retainer 107 in a bias direction (e.g., to a maximum displacement position). For example, as disclosed above, in certain embodiments, the bias direction can be a maximum pumping action direction.

In certain embodiments, e.g., as shown in FIG. 2A, the direct actuation mechanism 209, 210 includes a first arm 209a and a second arm 210a disposed on opposite sides of the tab 107a. The first arm 209a and second arm 210a can be configured to have complimentary actuation such that extension of the first arm 209a causes retraction of the second arm 210a to control the position of the retainer 107 without a biasing member (e.g., as shown in FIG. 1A) on the retainer 107. In certain embodiments, as shown in FIG. 2B, the system 200B can include a single side of direct actuation mechanism (e.g., just mechanism 209, e.g., a single screw actuator or rack and pinion or a servo, etc.) to control the displacement (e.g., with a spring as shown, or with nothing on the other side to resist or move in opposite parallel). Also, the second direct actuation mechanism 210 as shown in the embodiment of FIG. 2A can be replaced with a follower assembly that is passive to aid in guiding and/or limiting motion of the actuation mechanism 209.

In certain embodiments, as shown in FIG. 2B, the system 200B can be implemented with a spring arrangement and only a single side actuation similar to that shown in FIG. 1, The spring can counteract the mechanism and improve minimum to maximum displacement times, for example. Any suitable arrangement is contemplated herein.

Similarly, the embodiment of FIG. 1 can be implemented with two sides of controlled actuation similar to that shown in FIG. 2A without a biasing member 115 (e.g., a spring). Also, in certain embodiments, single side control of the embodiment of FIG. 1 is also contemplated. For example, pressures to either side of the actuator piston attached to the actuator rod 109a can be controlled such that a rod and head pressure would move the actuator piston as desired. This would allow for a no spring embodiment of the embodiment shown in FIG. 1 while also having single side actuation.

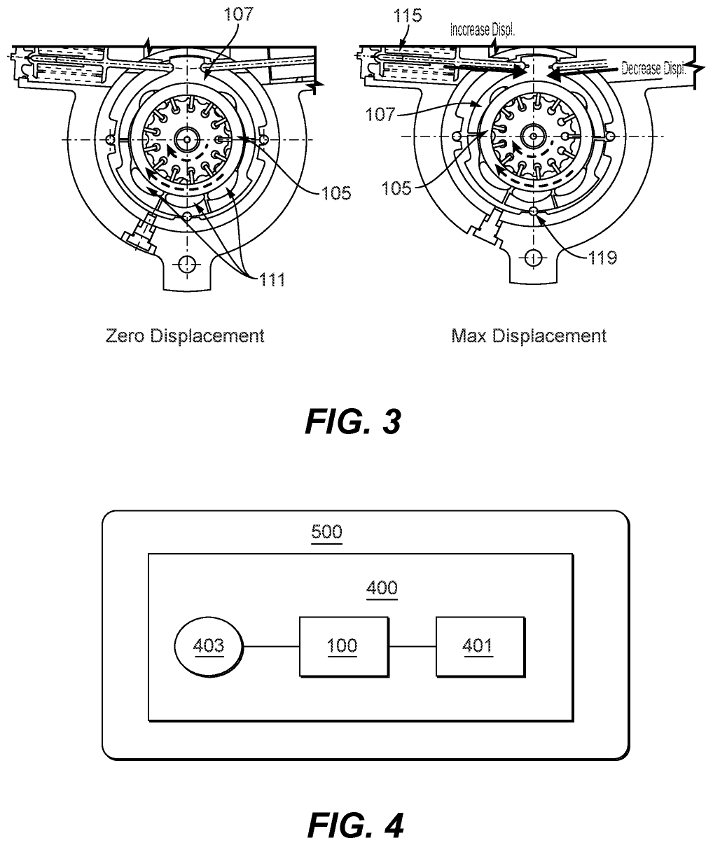

In accordance with at least one aspect of this disclosure, a method for controlling pumping action of a variable displacement pump can include directly controlling a position of a retainer to directly control pumping action of the pump using an electrohydraulic servo valve (EHSV) or a electromechanical arm assembly. For example, as shown in FIG. 3, the rotor 101 can be rotated (as well as the cam ring 105 as shown). To increase displacement from the zero displacement position as shown on the left of FIG. 3, the tab 107a on the retainer 107 can be moved to the right up to the maximum displacement position shown on the right of FIG. 3. Decreasing displacement (and thus pumping action) can be effected be moving the retainer 107 to the left. The method can include any other suitable method(s) and/or portion(s) thereof.

In accordance with at least one aspect of this disclosure, as shown in FIG. 4, a fuel pump system 400 for an aircraft 500 can include a fuel circuit 401 and a variable displacement pump 100 connected to the fuel circuit 401 (e.g., to pump fuel to an engine 403). The pump can be any suitable pump (e.g., pump 100, 200) disclosed herein, e.g., as described above. Any other suitable pump application is contemplated herein.

Traditional systems employ a complex hydraulic feedback loop to control displacement of variable displacement pumps. Embodiments enable direct control with a controller (e.g., an engine controller or any other suitable controller) which was not traditionally possible.

Certain embodiments utilize an EHSV instead of complex hydraulic network. An EHSV can utilize an existing hydraulic piston actuator from a traditional system, but allow for direct selective actuation with the EHSV. Direct feedback control is also enabled.

Embodiments can allow for removal of typical hydraulic controls and valving, and utilize incorporation of an electro-hydraulic servo valve (EHSV) that directly supplies pressure to the actuator piston within the variable vane pump. Differential pressure transducers reading the difference between the inlet and discharge pressures can be used to provide feedback to the controller (e.g., an engine controller). The controller could then change the current to the EHSV to directly change the displacement of the pump to reach the demanded pressure via displacement changes.

Accordingly, EHSVs can be sized such that they could provide direct hydraulic control to the actuator piston within the variable displacement vane pump, and thus, directly controlling the displacement of the pump. Embodiments of a pump no longer need to rely on complex hydraulic controls and can now be directly controlled by the engine controllers via a pressure feedback loop or a calculated required displacement vs a measured location (and thus displacement) via a position sensing mechanism such as an LVDT which measures the location of the retainer to determine the displacement.

Certain embodiments can utilize a non-hydraulic direct actuator without pistons, valves, or sensors for example. For example, a screw actuator or servo motor can allow direct arm control. Such actuators can have less components and less complexity, produce less lag between control input and displacement change, and provide a higher slew rate (e.g., the time between minimum and maximum displacement).

Typical variable displacement vane pumps have complex electro-hydraulic controls. Replacing the spring and hydraulic actuation piston and hydraulic controls with a screw actuator, linear actuator, or a rack and pinion with a servo, or any other suitable direct actuator reduces complexity and provides a mechanism for direct metering. Such embodiments can replace a compensation valve, an actuator piston, return springs, and an electro-hydraulic servo valve with a direct actuator in the form of a screw actuator, rack and pinion with a servo motor, or linear actuator, or any other suitable actuator.

Embodiments provide direct input to control the displacement of the pump can allow for direct metering of flow and more direct engine motor control over pump flow. Embodiments provide variable displacement vane pump direct displacement control, e.g., direct actuation control of a variable displacement vane pump.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A variable displacement pump, comprising:
a rotor having a plurality of vanes;
a cam ring surrounding the rotor and vanes, the vanes configured to extend from the rotor and contact an inner cam surface of the cam ring;
a retainer configured to contact the cam ring and to move the cam ring relative to the rotor to modify a pumping action; and
a direct actuation mechanism configured to control a position of the retainer to control a position of the cam ring and the pumping action.

2. The pump of claim 1, wherein the direct actuation mechanism is an electrohydraulic servo valve (EHSV) in direct hydraulic communication with the retainer via a hydraulic piston.

3. The pump of claim 1, wherein the direct actuation mechanism is a non-hydraulic electromechanical arm assembly.

4. The pump of claim 3, wherein the non-hydraulic electromechanical arm assembly includes a servo motor or screw actuator.

5. The pump of claim 1, further comprising a controller configured to directly control the direct actuation mechanism to achieve a desired pumping action.

6. The pump of claim 1, further comprising a biasing member configured to provide an opposing force to a direction of force applied by the direct actuation mechanism to bias the retainer in a bias direction.

7. The pump of claim 1, further comprising a housing, wherein the retainer is disposed on a pivot pin at a pivot location between, on, or in the retainer and the housing to allow the retainer to pivot relative to the housing.

8. The pump of claim 7, wherein the retainer includes a tab opposite or otherwise located apart from the pivot location, the tab configured to interact with an arm of the direct actuation mechanism to allow the direct actuation mechanism to apply a force to the tab to rotate the retainer about the pivot pin.

9. The pump of claim 8, further comprising a biasing member arm disposed on an opposite side of the tab relative to the arm of the direct actuation mechanism to provide an opposing force to a direction of force applied by the direct actuation mechanism to bias the retainer in a bias direction.

10. The pump of claim 9, wherein the bias direction is a maximum pumping action direction.

11. The pump of claim 8, wherein the direct actuation mechanism includes a first arm and a second arm disposed on opposite sides of the tab, wherein the first arm and second arm are configured to have complimentary actuation such that extension of the first arm causes retraction of the second arm to control the position of the retainer without a biasing member on the retainer.

12. A fuel pump system for an aircraft, comprising:
a fuel circuit; and
a variable displacement pump connected to the fuel circuit, the pump comprising:
a rotor having a plurality of vanes;
a cam ring surrounding the rotor and vanes, the vanes configured to extend from the rotor and contact an inner cam surface of the cam ring;
a retainer configured to contact the cam ring and to move the cam ring relative to the rotor to modify a pumping action; and
a direct actuation mechanism configured to control a position of the retainer to control a position of the cam ring and the pumping action.

13. The system of claim 12, wherein the direct actuation mechanism is an electrohydraulic servo valve (EHSV) in direct mechanical communication with the retainer via a hydraulic piston.

14. The system of claim 12, wherein the direct actuation mechanism is a non-hydraulic electromechanical arm assembly.

15. The system of claim 14, wherein the non-hydraulic electromechanical arm assembly includes a servo motor or screw actuator.

16. The system of claim 12, further comprising a controller configured to directly control the direct actuation mechanism to achieve a desired pumping action.

17. The system of claim 12, further comprising a biasing member configured to provide an opposing force to a direction of force applied by the direct actuation mechanism to bias the retainer in a bias direction.

18. The system of claim 12, further comprising a housing, wherein the retainer is disposed on a pivot pin at a pivot location between, on, or in the retainer and the housing to allow the retainer to pivot relative to the housing.

19. The system of claim 18, wherein the retainer includes a tab opposite or otherwise located apart from the pivot location, the tab configured to interact with an arm of the direct actuation mechanism to allow the direct actuation mechanism to apply a force to the tab to rotate the retainer about the pivot pin.

20. A method for controlling pumping action of a variable displacement pump, comprising:
directly controlling a position of a retainer to directly control pumping action of the pump using an electrohydraulic servo valve (EHSV) or a electromechanical arm assembly.
